(19) United States
(12) Patent Application Publication
(10) Pub. No.: US 2023/0054537 A1
(43) Pub. Date: Feb. 23, 2023

(54) METHOD FOR INSTANTIATING A NETWORK SERVICE AND CORRESPONDING APPARATUS

(71) Applicant: InterDigital CE Patent Holdings, Paris (FR)

(72) Inventors: Mario De Vito, Gévezé (FR); Stephane Onno, Saint Gregoire (FR); Ulises Olvera-Hernandez, Saint-Lazare (CA)

(21) Appl. No.: 17/796,061

(22) PCT Filed: Jan. 26, 2021
(86) PCT No.: PCT/EP2021/051662

§ 371 Date: Jul. 28, 2022

(30) Foreign Application Priority Data
Jan. 31, 2020 (EP) 20305086.9

(51) Int. Cl. H04L 45/586; H04L 45/036; H04L 45/00

(52) U.S. Cl. CPC H04L 45/586; H04L 45/036; H04L 45/38

(57) ABSTRACT

Instantiating a Network Service described by a Forwarding Graph comprising Virtual Network Functions, VNF instances, which are interconnected via communication links. This includes splitting the Forwarding Graph into n VNF Elementary Graphs, VNF EGs. Each of the VNF EGs for a VNF Instance includes routing information for forwarding, by that VNF instance and to another VNF instance, packets output by that VNF instance based on a packet class identifier included in the packet. Each of the VNF EGs is transmitted to the corresponding VNF instance for that VNF EG. Each of the VNF instances, when outputting a packet handled by it, then transmits the packet to a next VNF instance based on the packet class identifier included in the packet.

### FIELD

The present disclosure generally relates to the field of Network Function Virtualization (NFV) and in particular to Virtual Network Functions (VNFs).

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

In the context of Network Function Virtualization, network functions are implemented as Virtualized Network Functions that are executed on servers in Containers and/or Virtual Machines (VMs). A Network Service (NS) is defined as a set of VNFs interconnected through Virtual Links (VLs). The NS implements a complex network function, in which the VNFs comprising the NS communicate with each other via the VLs.

A so-called VNF Forwarding Graph (VNFFG) describes how the VNFs in an NS form a chain; the output data (result) of one VNF is the input data for another VNF. Packets take a route within the NS from one VNF to another, dependent on their content. So-called Forwarders are required per compute node (being the computing machine hosting one or more VNFs) which process packet traffic on the compute node, that is, they inspect packet content and depending on packet content steer the packet to a specific VNF. The Forwarders may contribute significantly to the overall packet transmission time and may cause important delays.

It is therefore desirable to provide a method and device for improved data communication between VNFs in an NS.

### SUMMARY

According to one aspect of the present disclosure, there is provided a method of instantiating a Network Service described by information representative of a Forwarding Graph comprising Virtual Network Functions, VNF instances. The method comprises: splitting the information representative of the forwarding graph into information representative of n VNF elementary graphs, one per VNF instance, wherein each of the elementary graphs for a VNF instance comprises routing information for forwarding, by the VNF instance, packets output by the VNF instance based on a packet class identifier comprised in the packets. The method further comprises: transmitting the information representative of each of the VNF elementary graphs to a corresponding VNF instance for that elementary graph. Further, the method comprises: each of the VNF instances, when the VNF instance outputs a packet processed by the VNF instance, transmitting, via one of the communication links, the packet to a next VNF instance based on the packet class identifier comprised in the packet.

According to a further aspect of the method of instantiating a Network Service, the method is implemented by at least one network entity corresponding to at least one VNF executing a 3GPP Session Management Function, SMF, the at least one VNF corresponding to a Control Plane network entity.

According to a further aspect of the method of instantiating a Network Service, the method further comprises a configuration of the VNF elementary graphs for relaying protocol messages through Network Entities according to one of: an Access and Mobility Management Function, AMF, and Access Network, AN, where the protocol messages are 3GPP Non-Access Stratum, NAS, protocol messages; a Network Exposure Function, NEF, and an Application Function, AF, where the protocol messages are 3GPP N33 messages.

According to a further aspect of the method of instantiating a Network Service, the method is implemented by at least one network entity corresponding to at least one VNF instantiated in 3GPP User Plane Functions, is executed at a Local Data Network or at a Data Network in one of: at least one Wireless Transmit-Receive Unit, WTRU, at least one Application Server, AS.

According to a further aspect of the method of instantiating a Network Service, the elementary graphs for a VNF instance comprising routing information for packet forwarding, are configured by a Session Management Function, SMF, onto User Plane Functions, UPFs, using Packet Detection Rules and Forward Action Rules.

According to a further aspect of the method of instantiating a Network Service, the elementary graphs for a VNF comprising routing information for packet forwarding, are configured by a Session Management Function, SMF, onto Wireless Transmit-Receive Units, WTRUs, using using Protocol Configuration Options and/or Quality of Service Profiles, conveyed using 3GPP Non-Access Stratum, NAS, messages, the NAS messages being any of a Protocol Data Unit, PDU, Session Establishment and a PDU Session Modification command.

According to a further aspect of the method of instantiating a Network Service, the elementary graphs for a VNF comprising routing information for packet forwarding, are configured by a Session Management Function, SMF, onto Application Servers, ASs, at Local Data Network, or a Data Network.

According to a further aspect of the method of instantiating a Network Service, one of the VNF instances implements a packet classifier function, the packet classifier function inserting, into packets input into the Network Service, the packet class identifier, based on a packet property.

According to a further aspect of the method of instantiating a Network Service, in a 3GPP network, a packet classifier function may be implemented as a Packet Filter Set used in the QoS rule and Packet Detection Rule (PDR) and Forward Action Rules (FAR) (related e.g., 3GPP TS 23.501).

According to a further aspect of the method of instantiating a Network Service, in a 3GPP network, the VNF instances may be realized as a component of a Network Function or Network Function Service or as the entire Network Function or Network Function service (related e.g., 3GPP TS 23.501 and TS 23.502).

According to a further aspect of the method of instantiating a Network Service, in a 3GPP network, the VNF instances may execute both User Plane and Control Plane functionality. The User Plane VNFs may use the configuration provided by the Control Plane VNFs to realize the NS chain. An embodiment of such mechanism may involve a 3GPP Control Plane entity such as the Session Management Function (SMF) or a part of it, configuring a User Plane Function (UPF) or a part of it (e.g., as part of the Uplink Classifier function part of the UPF) and a WTRU or part of it.

In addition, the SMF may configure VNFs part of and Application Server (AS), either directly using Control Plane Service Based Interfaces (SBIs) through an Application Function (AF) responsible to configure such ASs, or through a 3GPP Network Exposure Function (NEF) connecting AFs to the 3GPP Network. The AF and the ASs controlled by AFs, may be part of a central Data Network or an Edge Data Network. According to 3GPP, the NEF may communicate to trusted or external AF through the N33 network interface.

When configuring Network Service described by Forwarding Graphs, the SMF may avail of other Network Functions such as the AF, the NEF and the Access and Mobility Management Function (AMF) to relay configuration messages to VNFs executing in Network Entities such as the WTRU, the UPF and the AS.

According to a further aspect of the method of instantiating a Network Service, the packet property is at least one of a source address, a source port number, a destination address, a destination port number, a protocol identifier, a logical network interface identifier, a physical network interface identifier, a Central Processing Unit thread or process identifier, a Graphical Processing Unit thread or process identifier, a Protocol Data Unit Session Identifier (PDU Session ID), an Application Identifier, a QoS Profile and or a Packet Filter Set (related 3GPP TS 23.501).

According to a further aspect of the method of instantiating a Network Service, the packet property is determined by the VNF instances based on the routing information.

According to a further aspect of the method of instantiating a Network Service, the destination address is any of an Internet Protocol address, a Media Access Control address, a reference to an encapsulation transport format, a reference to an encapsulation protocol.

According to a further aspect of the method of instantiating a Network Service, the encapsulation transport format is Virtual Extensible Local Area Network, VxLAN.

According to a further aspect of the method of instantiating a Network Service, the encapsulation transport format is GPRS Tunneling Protocol (GTP).

According to a further aspect of the method of instantiating a Network Service, the encapsulation protocol is Generic Routing Encapsulation, GRE.

According to a further aspect of the method of instantiating a Network Service, the packet class identifier is inserted in one of: a Type of Service field in an IPv4 header; a flow label field in an IPv6 header; a physical network interface field, a logical network interface field, a Central Processing Unit thread or a process field, a Graphical Processing Unit thread or a process field or PDU layer (related 3GPP TS 23.501).

The present principles also relate to a device for instantiating a Network Service described by information representative of a forwarding graph comprising Virtual Network Functions, VNF instances, interconnected via communication links. The device comprises at least one processor configured to split the information representative of the forwarding graph into information representative of n VNF elementary graphs, one per VNF instance, wherein each of the elementary graphs for a VNF instance comprises routing information for forwarding, by the VNF instance, packets output by the VNF instance based on a packet class identifier comprised in the packets. The at least one processor is further configured to transmit each of the VNF elementary graphs to a corresponding VNF instance for that elementary graph. Each of the VNF instances, when the VNF instance outputs a packet processed by the VNF instance, is further configured to transmit, via one of the communication links, the packet to a next VNF instance based on the packet class identifier comprised in the packet.

According to a further aspect of the device, the device is at least one network entity corresponding to at least one VNF executing a 3GPP Session Management Function, SMF, the at least one VNF corresponding to a Control Plane network entity.

According to a further aspect of the device, the at least one processor is further configured to configure the VNF elementary graphs for relaying protocol messages through Network Entities according to one of: an Access and Mobility Management Function, AMF, and Access Network, AN, where the protocol messages are 3GPP Non-Access Stratum, NAS, protocol messages;

a Network Exposure Function, NEF, and an Application Function, AF, where the protocol messages are 3GPP N33 messages.

According to a further aspect of the device, the device is at least one network entity corresponding to at least one VNF instantiated in 3GPP User Plane Functions, executed at a Local Data Network or at a Data Network in one of: at least one Wireless Transmit-Receive Unit, WTRU, at least one Application Server, AS.

According to a further aspect of the device, the elementary graphs for a VNF instance comprising routing information for packet forwarding, are configured by a Session Management Function, SMF, onto User Plane Functions, UPFs, using Packet Detection Rules and Forward Action Rules.

According to a further aspect of the device, the elementary graphs for a VNF comprising routing information for packet forwarding, are configured by a Session Management Function, SMF, onto Wireless Transmit-Receive Units, WTRUs, using using Protocol Configuration Options and/or Quality of Service Profiles, conveyed using 3GPP Non-Access Stratum, NAS, messages, the NAS messages being any of a Protocol Data Unit, PDU, Session Establishment and a PDU Session Modification command.

According to a further aspect of the device, the elementary graphs for a VNF comprising routing information for packet forwarding, are configured by a Session Management Function, SMF, onto Application Servers, ASs, at Local Data Network, or a Data Network.

According to a further aspect of the device, one of the VNF instances is configured to implement a packet classifier function, the packet classifier function inserting, into packets input into the Network Service the packet class identifier, based on a packet property.

According to a further aspect of the device, the packet property is at least one of a source address, a source port number, a destination address, a destination port number, upper layer protocol identifier, physical network interface identifier, a logical network interface identifier, a Central Processing Unit thread or process identifier, a Graphical Processing Unit thread or process identifier.

According to a further aspect of the device, the destination address is any of an Internet Protocol address, a Media Access Control address, a reference to an encapsulation transport format, a reference to an encapsulation protocol.

According to a further aspect of the device, the encapsulation transport format is Virtual Extensible Local Area Network, VxLAN.

According to a further aspect of the device, the encapsulation protocol is Generic Routing Encapsulation, GRE.

According to further aspect of the device, the encapsulation protocol is GPRS Tunneling Protocol, GTP.

According to a further aspect of the device, the packet class identifier is inserted in one of: a Type of Service field in an IPv4 header, a flow label field in an IPv6 header, physical network interface field, a logical network interface field, a Central Processing Unit thread or a process field, a Graphical Processing Unit thread or a process field.

### BRIEF DESCRIPTION OF THE DRAWINGS

More advantages of the present disclosure will appear through the description of particular, non-restricting embodiments. To describe the way the advantages of the present disclosure can be obtained, particular descriptions of the present principles are rendered by reference to specific embodiments thereof which are illustrated in the appended drawings. The drawings depict exemplary embodiments of the disclosure and are therefore not to be considered as limiting its scope. The embodiments described can be combined to form particular advantageous embodiments. In the following figures, items with same reference numbers as items already described in a previous figure will not be described again to avoid unnecessary obscuring the disclosure. The embodiments will be described with reference to the following drawings in which:

FIG. 1 is a block diagram of an environment wherein the present principles can be applied.

FIG. 2 is an embodiment of a Network Service 200 according to the present principles.

FIG. 3a is a Forwarding Graph corresponding to NS 200, and illustrates the VNFs of FIG. 2 as nodes, and the communication links between the VNFs as edges.

FIG. 3b is a Forwarding Graph corresponding to another NS similar to NS 200 wherein the Forwarding Graph includes packets routed to VNF e.g., VNF4 , VNF5 located outside the 3GPP Network then further routed back to the 3GPP network e.g., through the N6-LAN

FIG. 4a depicts an Orchestrator that processes a Forwarding Graph of a Network Service (e.g., NS 200) and that outputs n Elementary Graphs or configuration data destined for each individual VNF in the NS.

FIG. 4b further depicts the dynamic deployment of Elementary Graphs by the SMF onto VNF (implementing 3GPP Network Functions) in a 3GPP System based on routing policies provided by the PCF (Policy Control

Function) and Forwarding Graph (FG) model provided by the Orchestrator 400. The SMF may execute the functions of 42 and 43, along with the routing policies provided by the PCF and build a set of elementary relationships between VNF placed onto WTRUs, UPFs and ASs.

FIG. 5 is an exemplary deployment of VNFs in a network including a core network and an edge network.

FIG. 6 is a different exemplary deployment of VNFs in a network including a core- and edge network.

FIG. 7 is a flow chart of an embodiment of the method for instantiating a network service described by a forwarding graph according to the present principles.

FIG. 8 is an embodiment of a device suitable for implementing the embodiments per aspects of the present disclosure.

It should be understood that the drawings are for purposes of illustrating the concepts of the disclosure and are not necessarily the only possible configuration for illustrating the disclosure.

### DETAILED DESCRIPTION

The present description illustrates the principles of the present disclosure. It will thus be appreciated that those skilled in the art will be able to devise various arrangements that, although not explicitly described or shown herein, embody the principles of the disclosure and are included within its spirit and scope.

All examples and conditional language recited herein are intended for educational purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

A so-called VNF Forwarding Graph (VNFFG) (or information representative of a VNFFG) describes how the VNFs in an NS form a chain; the output data (result) of one VNF is the input data for another VNF. Packets take a route within the NS from one VNF to another, dependent on their content. So-called Forwarders are required per compute node (being the computing machine hosting one or more VNFs) which process packet traffic on the compute node, that is, they inspect packet content and depending on packet content steer the packet to a specific VNF. The Forwarders may contribute significantly to the overall packet transmission time and may cause important delays.

As an example, a NS forming a chain can be characterized through a collection of VNFs in the form of 3GPP Network Functions and/or Network Function Services that are interconnected to deliver this service. A particular used case where such NS can be deployed, involved packets that are routed from the 3GPP Network to the part of an Network Operator where value added services such as firewalls, carrier-grade Network Addres Translator (NAT), deep packet inspection and policy control, can be found, and that is commonly refer to as N6-LAN. In addition, it is commonly required that these packets, once that they have traverse the N6-LAN, they be routed back to the 3GPP Network for further processing, where the NS chain is terminated, This type of Use Case is not well served with current technologies as those described above. It is therefore desirable to provide a method and device for improved data communication between VNFs in an NS.

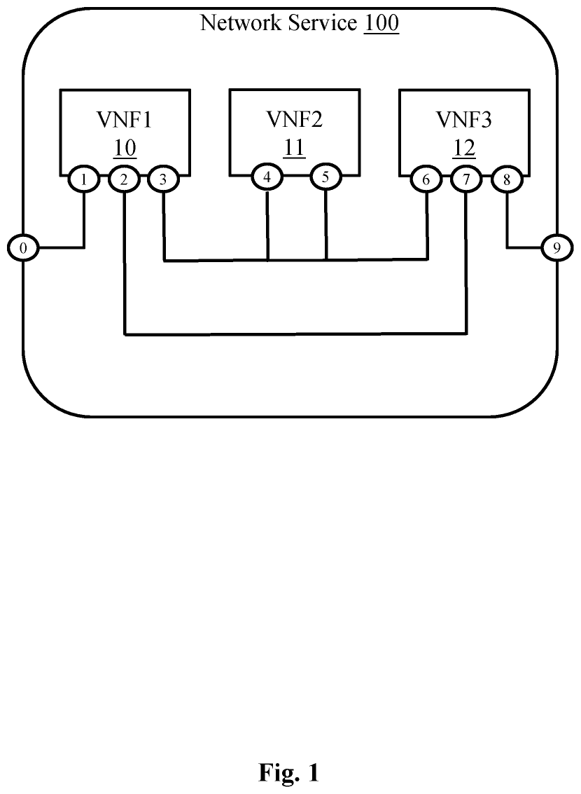

FIG. 1 is a block diagram of an environment wherein the present principles can be applied. An exemplary Network Service 100 includes three VNFs, VNF1 with reference 10, VNF2 with reference 11, and VNF3 with reference 12. Of course, the skilled person will readily acknowledge that a network service may include any number of VNFs. In the exemplary NS 100, packets are input on connection point (CP) CPO, and output at connection point CP9. A connection point may correspond to a network interface. Inside the NS 100, the VNFs are linked to the NS's input CP, to the NS's output CP, and to each other, via Virtual Links (VLs). A first VL, VL1, connects NS input CP0 to VNF1 (10) CP1. A second VL, VL2, connects CP2 of VNF1 (10) to CP7 of VNF3 (12). A third VL, VL3, connects CP3 of VNF1 (10) either to CP4 of VNF2 (11) or to CP6 of VNF3. A fourth VL, VL4, connects CP5 of VNF2 (11) to CP6 of VNF3 (12). As an example, there are three routes defined according to packet types/contents, which are referred here to ‘red’, ‘green’ and ‘blue’ packets although Fig.1 is in black and white. Red packets coming in at CP0 are processed by VNF1 (10) and resulting packets that are output by VNF1 (10) on CP2 should be input into VNF3 (12) on CP7 for further processing, and resulting packets should be output on CP8 to be output by the NS on CP9. Blue packets coming in at CPO should be input to VNF1 (10) on CP1 for processing by VNF1, results should be output on VNF1 (10) CP3, to be input on CP6 of VNF3 (12) for further processing by VNF3, and results of handling of these by VNF3 (12) that are output on VNF3 (12) CP8 should be handed over to NS output CP9. Green packets coming in at NS 100 CP0 should be input to VNF1 (10) CP1, results output on VNF1 (10) that are output on CP3 should be handed over to VNF2 (11) input CP4, and results of VNF2 treatment, coming out of VNF2 (11) CP5, should be handed over to VNF3 (12) input CP6, and results of VNF3 (12) treatment of green packets, output on VNF3 (12) CP8, should be transmitted to NS 100 output CP9.

It can thus be observed that inside the NS 100, the VNFs are ‘chained’ in a ‘graph’. The routing of packets is done by a function called ‘Forwarder’. The Forwarder inspects a Packet Class Identifier (PCI), which is added by a packet classifier function that may be instantiated in a VNF, which role is to add packet classifiers according to policy (e.g., ‘red’, ‘green’, or ‘blue’ policy). An index is further added which represents the packet position in the graph. This index gets an initial value when entering the NS and is decremented by each VNF on its route. The index makes the forwarding process ‘stateful’, i.e., the VNF update the ‘state’ (decrement the index) but ignores where to send the packet to. The Forwarders have this knowledge provided that the packet ‘state’ is set properly by the VNFs.

With the above described solution, a Forwarder is required per compute node (i.e., the computing machine hosting one or more VNFs). Forwarders may contribute significantly to packet transmission time between VNFs. The Forwarders must be configured and updated prior to deployment of VNFs. In addition, when a Network Service is implemented on infrastructures where a virtual link passes through a physical switch (router), such switch should support the chaining protocol as described above, thereby requiring specific hardware and/or software. In particular, these switches may need to support the Network Service Header (NHS) protocol.

Embodiments are described here that provide solutions to at least some of the above problems, including the state updating done by the VNFs and the added communication delays caused by the Forwarders, as well as the specific hardware requirement for any physical switches in routes between VNFs. A solution is provided herein where the index/state, as well as the Forwarders, are no longer required. Without the index field, the routing depends solely on the packet class. Any switches involved in the supporting infrastructure are no longer implied in the VNF chaining and may be basic items.

According to an embodiment, there is provided a new way of instantiating a (or information representative of a) Forwarding Graph (FG). The FG is distributed as configuration data among VNFs part of an NS, so that each VNF ‘knows’ to which VNF a packet of a given class is to be routed. The route of a packet is then solely determined by its class identifier, and does no longer depend on state information carried by an ‘index’ field; the system is therefore said to be stateless.

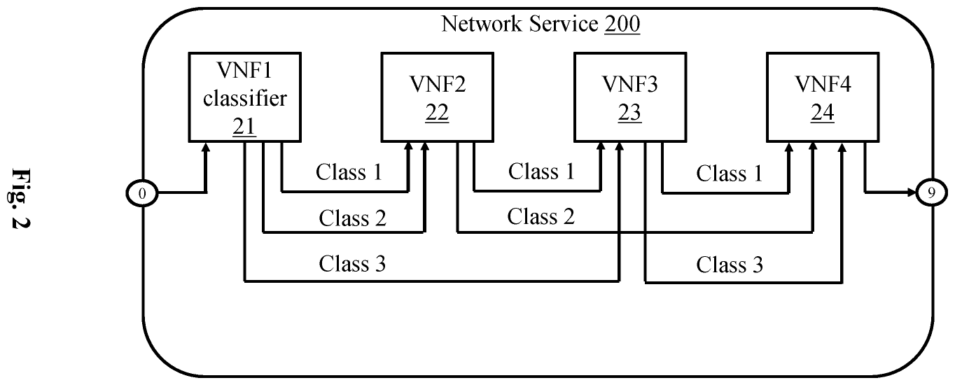

FIG. 2 is an embodiment of an exemplary Network Service 200 according to the present principles. The exemplary NS 200 includes four VNFs, VNF1 with reference 21, VNF2 with reference 22, VNF3 with reference 23 and VNF4 with reference 24. VNF1 21 includes a so-called Classifier function; it inserts, in the packets input into NS 200 at CP0, a (Packet) Class Identifier (CI or PCI) based on a packet property. For example, the packet property may be a source (IP) address and/or source port number, or a destination (IP) address and/or a destination port number, an identifier of a communication protocol used (‘protocol identifier’), for example an identifier of the User Datagram Protocol (UDP) or of the Transmission Control Protocol (TCP), for the IP protocol, a Central Processing Unit thread or process identifier, a Graphical Processing Unit thread or process identifier. According to an embodiment, the destination address is any of an Internet Protocol address, a Media Access Control address, a reference to an encapsulation transport format, a reference to an encapsulation protocol. According to an embodiment, the encapsulation transport format is Virtual Extensible Local Area Network, VxLAN. According to an embodiment, the encapsulation protocol is Generic Routing Encapsulation, GRE. According to yet another embodiment, the encapsulation protocol is GPRS Tunneling Protocol (GTP). According to an embodiment, the packet property is determined by the VNF instance implementing the packet classifier function, based on a configuration setting available to that VNF instance. According to a different embodiment, the packet property is determined by a VNF instance based on a configuration setting available to that VNF instance. According to an embodiment, the packet class identifier is inserted in one of: a Type of Service field in an IPv4 header, a flow label field in an IPv6 header, a physical network interface field, a logical network interface field, a Central Processing Unit thread or a process field, a Graphical Processing Unit thread or a process field. In this exemplary NS, packets with CI1 travel from VNF1 to VNF2, VNF3 and VNF4, while packets with CI2 travel from VNF1 to VNF2 and VNF4, while packets with CI3 travel from VNF1 to VNF3 and to VNF4 before being output at NS CP9.

The CI can be coded in a few bits. For example, in an IPv4 network, it is possible to use the ‘Type of Service’ (ToS) field; for IPv6, the ‘flow label’ field may be used to code the CI.

In addition, some VNFs of an NS may be deployed with a special request of having to share a same compute node (made up of CPUs and GPUs, Graphical Process Unit). In such cases, the CI may be a CPU/GPU process identifier or CPU/GPU thread identifier.

It can thus be observed that the described method, which does not rely or Forwarders, may use very efficient packet transfer protocols to speed up VNF to VNF communication, especially when VNFs of an NS share a same compute node.

The described method enables the use of packet processing acceleration means like Data Plane Development Kit (DPDK) or Single-Root Input/Output Virtualization (SR-IOV). In such cases, the CI may be either a physical network port/interface identified by a hardware identifier (e.g. PCI device address 0000:01:00.0) or a logical network interface (e.g. dpdk0).

The described method supports routing of packets from the 3GPP System to the N6-LAN and back into the 3GPP System by enabling SMF to deploy and configure NS enabled by FGs into VNF (e.g. AS) deployed at the Data Network,e.g., directly through an AF or through an AF connected to the 3GPP System through a NEF API (i.e., interface).

The N6-LAN is the part of a network operator, between the 3GPP system and the Data Network, where value added services are typically provided. This is where functions such as firewalls, parental control, deep packet inspection, policy control and content optimization are found.

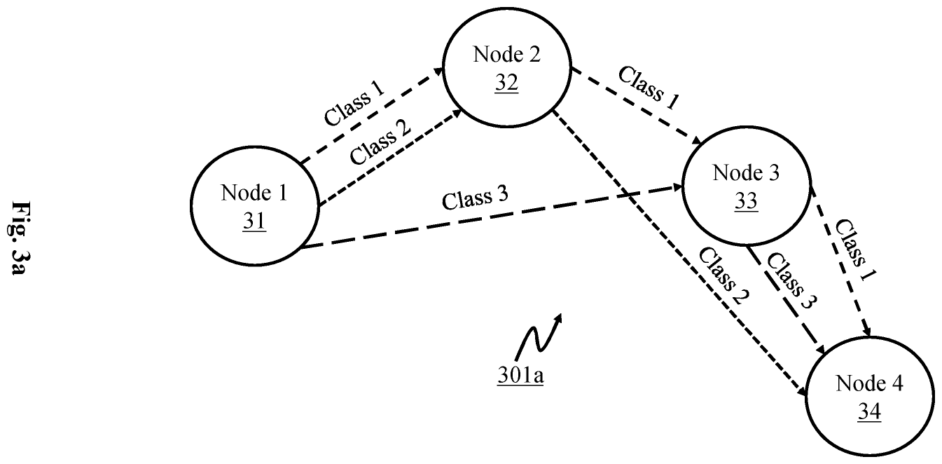

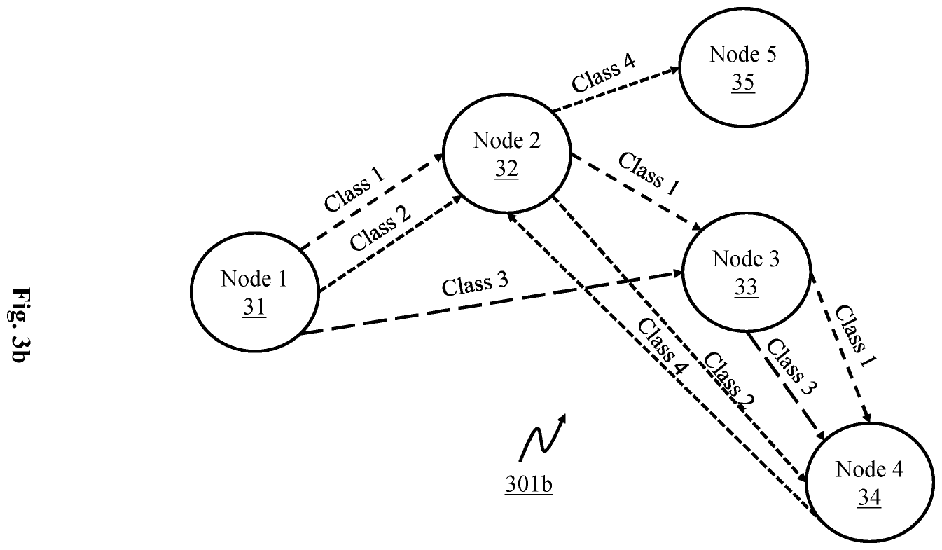

FIG. 3a is a Forwarding Graph 301a corresponding to NS 200, and illustrates the VNFs VNF1, VNF2, VNF3 and VNF4 of FIG. 2 respectively as nodes 1 with reference 31, node 2 with reference 32, node 3 with reference 33 and node 4 with reference 34 and the packet paths between the nodes as edges.

FIG. 3b is a Forwarding Graph 301b corresponding NS, similar to NS 200 illustrated in FIG. 3a, wherein the Forwarding Graph includes packets routed to VNFs e.g., to VNF4 (node 34), located outside the 3GPP Network then further routed back to the 3GPP network e.g., through the N6-LAN and then further routed to yet another VNF, e.g., to VNF 5 (node 35).

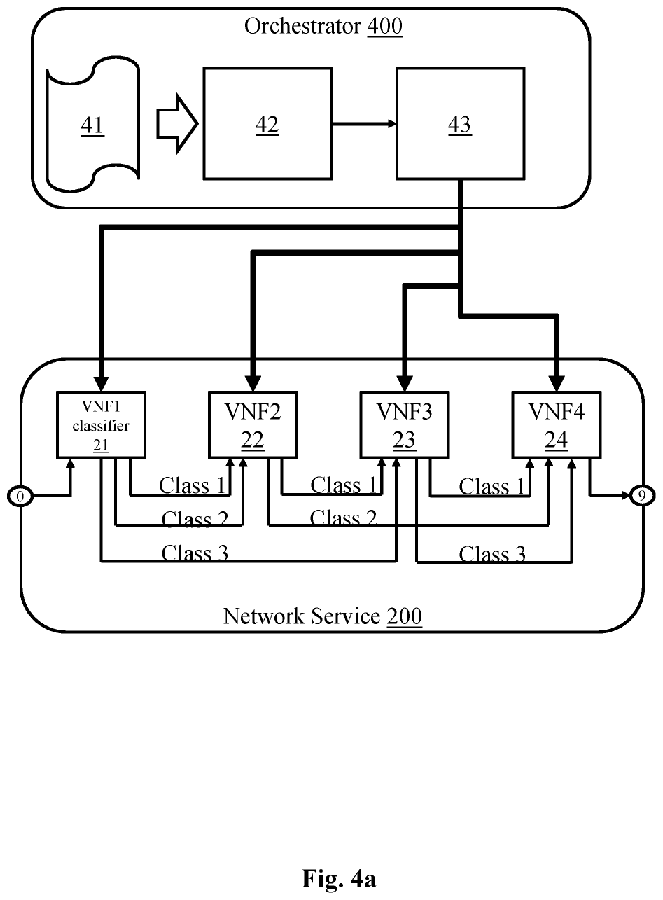

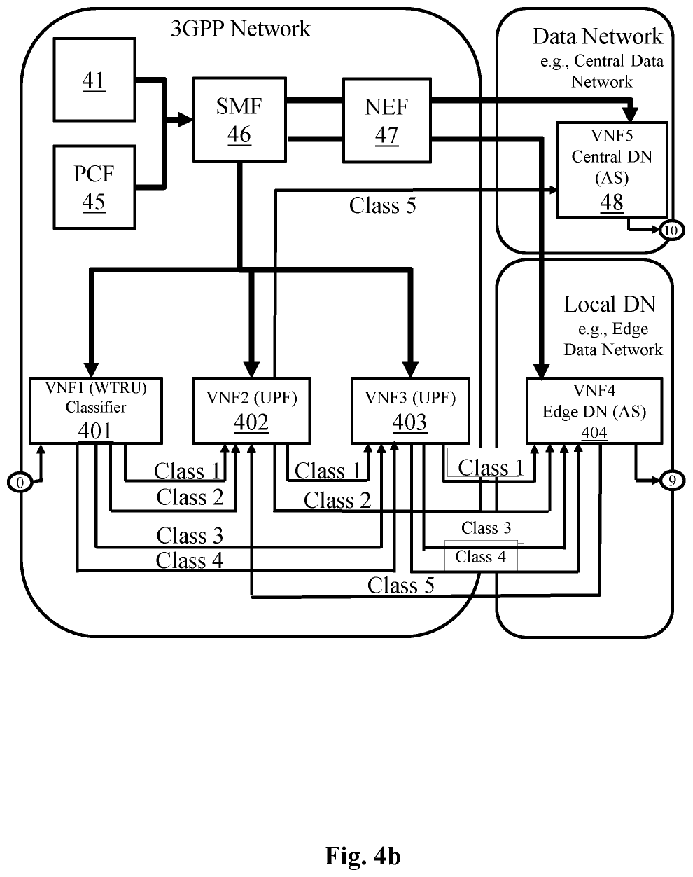

FIG. 4a depicts an Orchestrator 400 that processes a Forwarding Graph (or information representative of a Forwarding Graph) of a Network Service (e.g., NS 200) and that outputs n Elementary Graphs (or information representative of Elementary Graphs or configuration data) destined for each individual VNF in the NS. Now further building on what is explained with the help of FIGS. 2 and 3, a Forwarding Graph model 41 may be defined which describes forwarding graph 301. The Forwarding Graph model 41 includes a set of network function paths, each identified by a class identifier produced by the packet class identifier function, and which class identifier is inserted into particular packets by that function. This forwarding graph model 41 is used in a so-called Orchestrator 400 which includes a graph breakdown function 42 and a VNF configuration system 43. The forwarding graph model 41 is fed into a graph breakdown function 42 which decomposes the forwarding graph model 301 into a set of elementary relationships between VNFs and neighboring VNFs. Graph breakdown function 42 may produce the following relationship data:

(class 1, VNF1, VNF2)

(class 1, VNF2, VNF3)

(class 1, VNF3, VNF4)

(class 2, VNF1, VNF2)

(class 2, VNF2, VNF4)

(class 3, VNF1, VNF3)

(class 3, VNF3, VNF4)

The above relationship data (information) is input into a VNF configuration system 43 which transforms (splits) this data into data destined for each individual VNF so that the destination address of the packets going out of that VNF only depends on the packet class identifier. The destination address may be the IP address/port of a VNF, the destination Media Access Control (MAC) address, a reference (identifier of) to an encapsulation transport format like Virtual Extensible LAN (VxLAN), Generic Routing Encapsulation (GRE) protocol or any other type of overlay or underlay protocol/format, logical network interface field, a physical network interface field, a CPU thread or a process field, a GPU thread or a process field.

Given the example above, the VNF configuration system 43 would generate the following data:

Elementary graph data (VNFEG) for VNF1:
class 1 packets to be routed to VNF1, class 2 packets to be routed to VNF2, class 3 packets to be routed to VNF3

Elementary graph data for VNF2:
class 1 packets to VNF3, class 2 packets to VNF4

Elementary graph data for VNF3:
class 1 packets to VNF4, class 3 packets to VNF4

Elementary graph data for VNF4:
class 1/2/3 packets to CP9

Each of the elementary graphs for a VNF instance thus includes routing information for forwarding, by that VNF instance, packets output by that VNF instance based on packet class identifiers included in those packets. The elementary graph data is then transmitted to the VNFs, illustrated by thick arrows in FIG. 4. Elementary graph data for VNF1 is transmitted to VNF1, elementary graph data for VNF2 is transmitted to VNF2, elementary graph data for VNF3 is transmitted to VNF3, and elementary graph data for VNF4 is transmitted to VNF4.

The routing information for a VNF instance may include a specific configuration of the packet property that the VNF instance uses for forwarding a packet to another VNF instance. For example, VNF2 may insert the Packet Class Identifier in the IPv4 ToS when forwarding class 1 packets to VNF4, while it may use a process ID when forwarding class 1 packets to VNF3 (for example, when VNF2 and VNF3 are executed on a same CPU).

FIG. 4b depicts a 3GPP System, and in particular an SMF 46, configured to dynamically deploy a Forwarding Graph corresponding to a Network Service according to routing policies provided by the PCF and a Forwarding Graph model provided by the Orchestrator 400. The SMF may execute the functions of 42 and 43, along with the routing policies provided by the PCF 45 and build a set of elementary relationships between VNFs placed onto WTRUs (401), UPFs (403, 404) and ASs (48, 404). When the SMF configures elementary relationships in VNFs placed in an AS, the SMF can address the AS either directly through an AF, or indirectly using the Network Exposure Function (NEF) 47. The NEF exposes an interface in the form of APIs (Application Programming Interfaces) so as to enable entities outside the 3GPP network, to interact with a 3GPP System.

A graph breakdown function computed in the SMF may produce the following relationship data:

(class 1, VNF1, VNF2)

(class 1, VNF2, VNF3)

(class 1, VNF3, VNF4)

(class 2, VNF1, VNF2)

(class 2, VNF2, VNF4)

(class 3, VNF1, VNF3)

(class 3, VNF3, VNF4)

(class 4, VNF1, VNF4)

(class 4, VNF4, VNF2)

(class 4, VNF2, VNF5)

The above relationship data is input into a VNF(s) realizing SMF functionality, which transforms (splits) this data into data destined for each individual VNF so that the destination address of the packets going out of that VNF only depends on the packet class identifier. The destination address may be the IP address/port of a VNF, the destination Media Access Control (MAC) address, a reference (identifier of) to an encapsulation transport format like Virtual Extensible LAN (VxLAN), Generic Routing Encapsulation (GRE) protocol or any other type of overlay or underlay protocol/format, logical network interface field, a physical network interface field, a CPU thread or a process field, a GPU thread or a process field, Application ID or PDU Session ID, a QoS profile and or a Packet Filter Set as defined in 3GPP TS 23.501.

Given the example above, the SMF may generate the following data:

Elementary graph data (VNFEG) for VNF1 (VVTRU):
class 1 and class 2 packets to be routed to VNF2 (UPF), class 3 and class 4 packets to be routed to VNF3 (UPF)

Elementary graph data for VNF2:
class 1 packets to VNF3 (UPF), class 2 packets to VNF4 (Edge DN), class 4 to VNF5 (Central DN) and to CP10

Elementary graph data for VNF3:
class 1, class 3 and class 4 packets to VNF4 (Edge DN)

Elementary graph data for VNF4:
class 1, class 2, and class 3 packets to Edge DN and to CP9, class 4 packets to VNF2 (UPF)

The SMF may configure FG according to different communication protocols depending on the target VNF.

According to an embodiment, the SMF may configure the WTRU using Protocol Configuration Options and/or QoS Profiles conveyed via the Non-Access Stratum (NAS) protocol. The SMF may use a PDU Session

Establishment Accept message or a PDU Session Modification Command message for configuration of FG into the WTRU.

According to another embodiment, the SMF may configure a UPF through the 3GPP N4 interface, e.g., by enhancing Packet Detection Rules (PDR) and Forward Action Rules (FAR) part of the Packet Forwarding Control Protocol (PFCP) realizing the N4 interface or an equivalent protocol such OpenFlow or P4.

According to another embodiment, the SMF may configure FG in VNFs part of ASs either using an AF directly or through NEF 47. These AF and AS may be either a Central Data Network, or part of it, or an Edge Data Network or part of it.

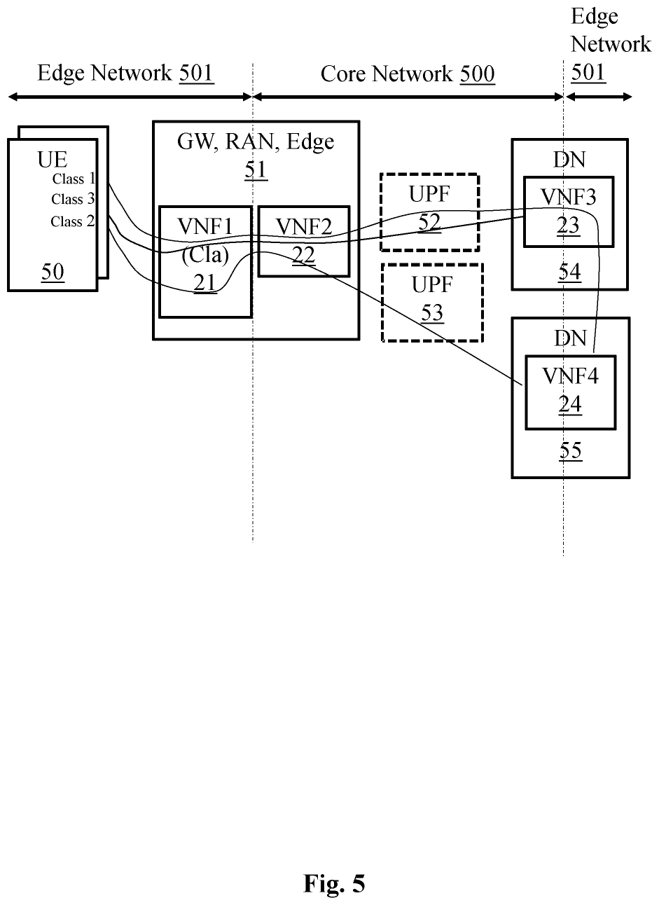

FIG. 5 is an exemplary deployment of the VNFs 1, 2, 3 and 4 corresponding to respectively references 21, 22, 23 and 24 in a network including a Core Network 500 and an edge network 501. The VNF1 (21), implementing a classifier function, and VNF2 (22) are implemented in, for example, a gateway (GW), a Radio Access Network (RAN), or an Edge 51. VNF3 (23) is implemented in a Data Network (DN) 54, while VNF4 (24) is implemented in a DN 55. Core Network (CN) 500 includes part of GW/RAN/Edge 51 to part of DNs 54, 55, and optionally User Plane Functions

(UPF) 52 and 53. The Edge Network (EN) 501 includes plurality of User Equipments (UE) 50 and part of GW/RAN/Edge 51, and part of DNs 54 and 55. The curved lines indicate packet flows. A RAN 51 may be a Cloud RAN or Virtual RAN composed of a set of Base Band Units (BBUs) that serve a set of distant Remote Radio Heads (RRHs) from fronthaul communication links. A Fronthaul communication link separates a BBU from RRH at different communication layers L1/L2/L3. Identification means of the RRH resource entering the BBU may be used as classifier identifier for VNF1 (21) to forward the output packets to VNF2 (22), VNF2′ (another instance of VNF2, not shown in FIG. 5) or VNF3 (23). An Edge 51 may be any V2X (vehicle-to-everything) compute node for a road infrastructure such as Vehicle On-Board Unit or Equipment (OBU or OBE), Roadside Unit or Equipment (RSU or RSE), Safe Communication Channel. An Edge 51 may be an ARNR/XR (Augmented, Virtual, Mixed Reality) Edge compute close to UE rendering to satisfy low latency constraints such as motion-to-photon latency. Edge 51 may be an Edge server located near or colocated with a RAN node serving Unnamed Aerial Vehicle (UAV), a Remotely Piloted Aircraft System (RPAS), Unmanned Aircraft System (UAS). For such cases, it may implement one or several VNFs for Image processing for example fire detection or dynamic object tracking. Edge 51 may be an enhanced Mobile Broadband unit such EMBB/SMBS or a CDN edge network delivery.

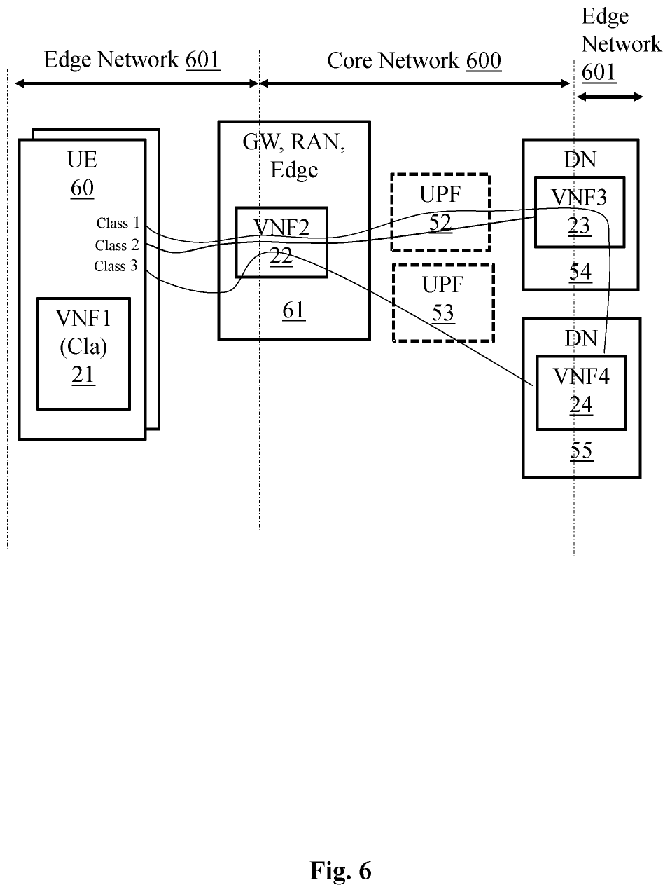

FIG. 6 is a different exemplary embodiment of VNFs 1-4 in a network. Here, an edge network 601 includes UEs 60, part of GW/RAN/Edge 61, part of DNs 54 and 55. UEs 60 include the classifier VNF1 (21), while GW/RAN/Edge 61 now only includes VNF2 (22). The core network 600 includes part of GW/RAN/Edge 61, optionally UPFs 52 and 53, and part of DNs 54 and 55. A UE may be a simple mobile phone, an AR/VR/XR User Equipment, an Unnamed Aerial Vehicle (UAV), a Remotely Piloted Aircraft

System (RPAS), Unmanned Aircraft System (UAS), a Robot or a Car equipped with a strong computing power unit for processing many tasks before sending the packet to the edge. In such cases, a UE may comprise a set of several VNF inside (not represented in FIG. 6) for processing UE specific tasks requiring very low latencies or for security or privacy concerns. The UE can also perform similar tasks or pre-processing tasks for VNFs of Edge 61.

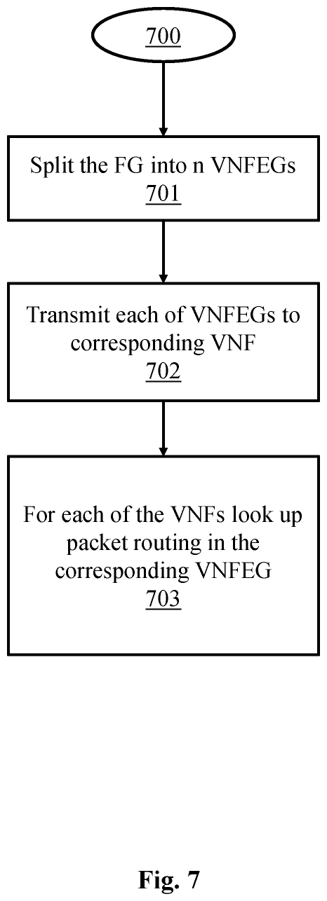

FIG. 7 is a flow chart of an embodiment of the method 700 for instantiating a network service described by a forwarding graph comprising Virtual Network Functions implemented by VNF instances according to the present principles. In 701, the forwarding graph is decomposed (split) into n VNF elementary graphs (VNF EGs), one per VNF instance, each of the elementary graphs comprising routing information for forwarding, by the corresponding VNF instance, packets output (processed, handled) by that VNF instance, to the next VNF instance (or to the NS output CP) based on a packet class identifier comprised in the packet. In 702, each of the VNF EGs is transmitted to the corresponding VNF instance for that elementary graph. In 703, each of the VNF instances, when outputting a packet processed by it, transmits the packet to the next VNF instance, or to the NS output connection point, based on the packet class identifier comprised in the packet, using the information comprised in its elementary graph.

The proposed embodiments may among others be used within the context of ETSI/MANO (European Telecommunications Standards Institute/Management and Orchestration). Among the many use cases described in the ETSI/MANO project, the Mobile-Edge Computing (MEC) service shows a very complex Network Service, that bridges three major standardization works: ETSI/MANO, MEC, and 3GPP (including 4G and 5G). The embodiments described in the present document may help to reach the high data rates required by, notably, new 5G applications. MANO benefits include a capability to deploy applications on a heterogenous set of hosting infrastructures called Network Function Virtualization Infrastructure (NFVI) and is of particular interest for deploying MEC hosts, which are supposed to be executed on relatively small computing resources located on the edge of the mobile network in a cloud like environment. In the MEC, each Mobile-Edge application (ME application) may comprise a set of VNFs, managed by MANO in another set of VNFs: the MEC orchestrator. Orchestrator 400 of FIG. 4 may be a MEC orchestrator, which would enable the MEC orchestrator to benefit from certain advantages, such as:
no need to implement Forwarder functions in the NFVI, as each VNF sends itself the packets it has processed to the next VNF.
No need to keep track ‘states’ in the form of indexes, as the relevant part of the forwarding graph for a VNF, i.e. an elementary graph, is stored in the VNF as configuration data. Indexing is useless, packet overhead is reduced.
The system now being stateless, recovery from crash is easier and quicker.

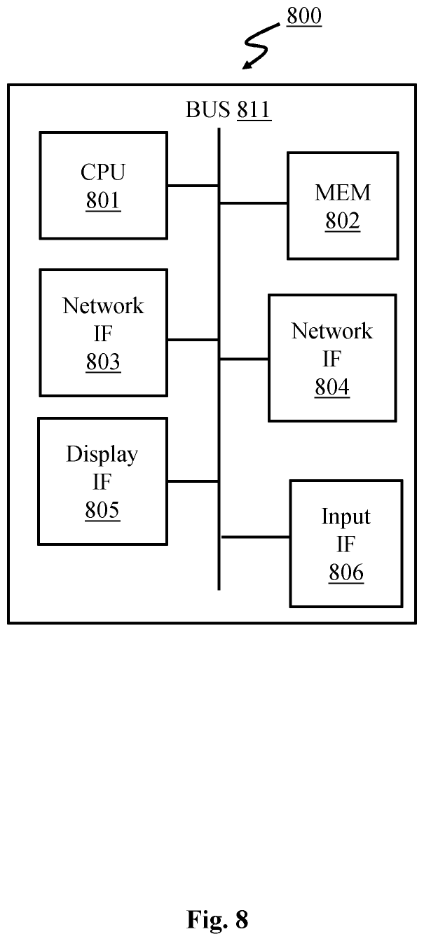

FIG. 8 is an embodiment of a device suitable for implementing embodiments per the principles of the present disclosure. The device 800 is for example an access point device, a gateway, or a mobile communication device. The device includes at least one processor or central processing unit or processor 801, a memory 802, a first network interface 803 for connection to a WLAN, for example of the IEEE802.11 (Wifi) type, and a second network interface 804 for connection 820 to another WLAN or a RAN, for example of the 3,4 or 5G (New Radio, NR) type. Device 800 may optionally comprise a display interface 805 and/or an input interface 806. Display interface 805 and input interface 806 may be combined in a single unit. The elements 800-803 are interconnected via an internal data communication bus 811. Memory 802 is configured to store machine readable instructions which can be executed by processor 801. Device 800 is suitable for instantiating a Network Service described by a Forwarding Graph comprising Virtual Network Functions, VNF instances, interconnected via communication links. The at least one processor 801 is configured to split the forwarding graph into n VNF elementary graphs, one per VNF instance, wherein each of the elementary graphs for a VNF instance comprises routing information for forwarding, by the VNF instance, packets output by the VNF instance based on a packet class identifier comprised in the packets. The at least one processor 801 is further configured to transmit each of the VNF elementary graphs to a corresponding VNF instance for that elementary graph. Each of the VNF instances, when the VNF instance outputs a packet processed by the VNF instance, is configured to transmit, via one of the communication links, the packet to a next VNF instance based on the packet class identifier comprised in the packet.

It is to be appreciated that some elements in the drawings may not be used or be necessary in all embodiments. Some operations may be executed in parallel. Embodiments other than those illustrated and/or described are possible. For example, a device implementing the present principles may include a mix of hard- and software.

It is to be appreciated that aspects of the principles of the present disclosure can be embodied as a system, method or computer readable medium. Accordingly, aspects of the principles of the present disclosure can take the form of an entirely hardware embodiment, an entirely software embodiment (including firmware, resident software, micro-code and so forth), or an embodiment combining hardware and software aspects that can all generally be defined to herein as a “circuit”, “module” or “system”. Furthermore, aspects of the principles of the present disclosure can take the form of a computer readable storage medium. Any combination of one or more computer readable storage medium(s) can be utilized.

Thus, for example, it is to be appreciated that the diagrams presented herein represent conceptual views of illustrative system components and/or circuitry embodying the principles of the present disclosure. Similarly, it is to be appreciated that any flow charts, flow diagrams, state transition diagrams, pseudo code, and the like represent various processes which may be substantially represented in computer readable storage media and so executed by a computer or processor, whether such computer or processor is explicitly shown.

A computer readable storage medium can take the form of a computer readable program product embodied in one or more computer readable medium(s) and having computer readable program code embodied thereon that is executable by a computer. A computer readable storage medium as used herein is considered a non-transitory storage medium given the inherent capability to store the information therein as well as the inherent capability to provide retrieval of the information there from. A computer readable storage medium can be, for example, but is not limited to, an electronic, magnetic, optical, electromagnetic, infrared, or semiconductor system, apparatus, or device, or any suitable combination of the foregoing. Some or all aspects of the storage medium may be remotely located (e.g., in the ‘cloud’). It is to be appreciated that the following, while providing more specific examples of computer readable storage mediums to which the present principles can be applied, is merely an illustrative and not exhaustive listing, as is readily appreciated by one of ordinary skill in the art: a hard disk, a read-only memory (ROM), an erasable programmable read-only memory (EPROM or Flash memory), a portable compact disc read-only memory (CD-ROM), an optical storage device, a magnetic storage device, or any suitable combination of the foregoing.

1-29. (canceled)

30. A method for instantiating a network service comprising virtual network function instances (vnf instances), the vnf instances being interconnected via communication links, the method comprising:
splitting chaining information relative to the vnf instances in the network service forming a chain via the communication links, into routing information for each vnf instance, the routing information comprising information for forwarding, by each vnf instance, packets output by the respective vnf instance based on identifier information in the packets;
transmitting the routing information for each vnf instance to a corresponding vnf instance; and
transmitting, by each vnf instance, via one of the communication links, a packet processed by the respective vnf instance to an input of another vnf instance, based on the identifier information in the packet and according to the routing information received by the respective vnf instance.

31. The method according to claim 30, wherein the chaining information relative to the vnf instances in the network service forming a chain via the communication links is a forwarding graph, and the routing information for each vnf instance is an elementary graph.

32. The method according to claim 30, wherein the method is implemented by at least one network entity corresponding to at least one vnf instance implementing a session management function, the at least one vnf instance corresponding to a control plane network entity.

33. The method according to claim 30, wherein the method is implemented by at least one network entity corresponding to at least one vnf instance instantiated in user plane functions, in a local data network or in a data network in one of at least one wireless transmit-receive unit and at least one application server.

34. The method according to claim 30, wherein the routing information is configured by a session management function, onto user plane functions, using packet detection rules and forward action rules.

35. The method according to claim 30, wherein the routing information is configured by a session management function, onto wireless transmit-receive units, using protocol configuration options and/or quality of service profiles, transmitted using non-access stratum messages, being any of a protocol data unit, session establishment and a protocol data unit session modification command.

36. The method according to claim 30, wherein the routing information is configured by a session management function, onto application servers, at a local data network, or a data network.

37. The method according to claim 30, wherein one of said vnf instances implements a packet classifier function, the packet classifier function inserting, into packets input into the network service, the identifier information, based on a packet property.

38. A device for instantiating a network service comprising virtual network function instances (vnf instances), the vnf instances being interconnected via communication links, the device comprising at least one processor configured to:
split chaining information relative to the vnf instances in the network service forming a chain via the communication links, into routing information for each vnf instance, the routing information comprising information for forwarding, by each vnf instance, packets output by the respective vnf instance based on identifier information in the packets;
transmit the routing information for each vnf instance to a corresponding vnf instance; and
transmit, by each vnf instance, via one of the communication links, a packet processed by the respective vnf instance to an input of another vnf instance, based on the identifier information in the packet and according to the routing information received by the respective vnf instance.

39. The device according to claim 38, wherein the chaining information relative to the vnf instances in the network service forming a chain via the communication links is a forwarding graph, and the routing information for each vnf instance is an elementary graph.

40. The device according to claim 38, wherein the device is at least one network entity corresponding to at least one vnf instance implementing a session management function, the at least one vnf instance corresponding to a control plane network entity.

41. The device according to claim 38, wherein the device is at least one network entity corresponding to at least one vnf instance instantiated in user Plane functions, implemented at a local data network or at a data network in one of: at least one wireless transmit-receive unit, at least one application server.

42. The device according to claim 38, wherein the routing information is configured by a session management function onto user plane functions, using packet detection rules and forward action rules.

43. The device according to claim 38, wherein the routing information is configured by a session management function, onto wireless transmit-receive units, using protocol configuration options and/or quality of service profiles, transmitted using non-access stratum messages, being any of a protocol data unit, session establishment and a protocol data unit session modification command.

44. The device according to claim 38, wherein one of the vnf instances implements a packet classifier function, the packet classifier function inserting, into packets input into the network service, the identifier information, based on a packet property.
